(19) United States
(12) Patent Application Publication
(10) Pub. No.: US 2012/0148119 A1
(43) Pub. Date: Jun. 14, 2012

(54) METHOD AND SYSTEM FOR ESTIMATING THE PERCEIVED AGE OF AN INDIVIDUAL

(76) Inventor: Steven H. Dayan, Chicago, IL (US)

(21) Appl. No.: 13/326,115

(22) Filed: Dec. 14, 2011

Related U.S. Application Data
(60) Provisional application No. 61/422,747, filed on Dec. 14, 2010.

(51) Int. Cl. G06K 9/46

(52) U.S. Cl. 382/118

(57) ABSTRACT

A system wherein various facial properties/features are observed and wherein such facial properties are given numerical representations based upon predetermined criteria. The selected numerical representations are then calculated in a manner that results in a perceived age of the individual. Cosmetic and/or surgical alterations or enhancements can then be made physically to the individual and/or via graphic representation to the individual's face, in accordance with changes based upon the numerical representations given for one or more of the observed features.

### RELATED APPLICATIONS

This application claims priority to U.S. Provisional Patent Application No. 61/422,747 filed on Dec. 14, 2010, the entirety of which is incorporated herein by reference.

### FIELD OF THE INVENTION

The present invention is directed towards a method of determining a person's perceived age, and more particularly, determining the perceived age based upon various facial features and using collected information regarding same to aide in adjusting certain facial features of the individual to lower said perceived age.

### BACKGROUND OF THE INVENTION

In some people there is a difference between their actual age and the age that they appear to be (i.e., “their perceived age”). This difference can be a result of various factors including but not limited to, environmental factors, life style choices, genetics, etc. Therefore, many people wish to adjust their perceived age, so that it is closer to or lower than their actual age.

For example, one method that people may choose to utilize to adjust their perceived age is plastic surgery. There are numerous plastic surgery options available for various features of a person's image.

Thus, a person utilizing plastic surgery to adjust their perceived age has a variety of surgical options available, and in some instances, a variety of options available on a single characteristic of that person's image.

Therefore, there is a need for a method and a system that can determine a person's perceived age.

Furthermore, there is a need for a method and system that can use the collected information association with determining a person's perceived age and determine a hypothetical perceived age based upon various modifications of that person's image, and create a hypothetical image of the hypothetical perceived age.

The present invention seeks to provide a system and a method that allows for these, as well as other, benefits.

### BRIEF DESCRIPTION OF THE PRESENT INVENTION

In one embodiment of the present invention, the invention is directed towards a method for determining the perceived age of an individual.

This embodiment may include the steps of identifying one or more aging related facial features associated with a human's face, identifying a perceived state for each of such features, assigning a numerical representation to each feature based upon the perceived state of such features, and/or calculating the assigned numerical representations associated with each of the perceived states of each of such features. Such a calculation results in a perceived age of the individual, regardless of the individual's true age.

The step of identifying one or more aging related facial features may include identifying one or more various locations on an individual's face prone to wrinkles, skin alterations, skin elasticity, skin folds, muscle condition, lip condition, cheek properties and eye area properties.

The step of identifying one or more aging related facial features may also includes identifying one or more of the categories identified in FIG. 1.

In some embodiments, the step of identifying a perceived state comprises determining whether such a perceived state is non-existent, mild, moderate or severe.

Further, the step of assigning numerical representations may comprise assigning a predetermined number based upon one or more of the state of the age related feature and the perceived impact such a state has on the perceived age of individuals. The step of assigning a predetermined number may comprise assigning the numbers identified in FIG. 1.

The step of calculating the assigned numerical representations associated with each of the perceived states of each of such features may comprise determining the perceived age of the individual by adding the assigned numbers together.

Certain embodiments may also include the steps of altering one or more of the perceived states, and, in turn, identifying a new perceived age of the individual based upon such alterations. The step of altering may comprise the step altering graphically (via, for example, computer generation), cosmetically and/or surgically.

In some embodiments of the invention, the invention is directed to a system for estimating a perceived age of an individual and for altering the individual's facial appearance to a desired perceived age.

The system may comprise a data base indicating one or more facial, neck and hair features associated with aging, wherein the data base includes numerical representations associated with one or more levels of severity associated with each particular feature, and means for determining a perceived age of an individual based upon the severity of the age related features.

The system may further include means for altering one or more of the age related features to a lower level of severity. For example, the altering means may comprise a computer generated image of the individual with the altered features. Further, the altering means may include a comparison of the individual's current features with the computer generated image.

The system may further include means for providing a hypothetical perceived age of an individual based upon an alteration of the severity of one or more of the age related features.

These various embodiments of the present invention provide a system and method for determining a person's perceived age. Based upon the information associated with the various features of the person, a doctor, clinician or other individual can use the information to provide advice on the adjustment of certain features as those features relate to the perceived age. In other words, a doctor could explain that by correcting (i.e., surgery or cosmetic procedure) mild Crows Feet would lower a perceived age by two years, whereas, correcting (i.e., surgery or cosmetic procedure) mild Glabellar Wrinkles would lower the perceived age by one year.

Furthermore, one or more embodiments described above allows for the doctor, clinician or other individual to create images of the hypothetical perceived age.

These benefits as well as others will be readily apparent to those of ordinary skill in the art in view of the following detailed description and attached drawings.

It is to be understood that the aspects and objects of the present invention described above may be combinable and that other advantages and aspects of the present invention will become apparent to those having ordinary skill in the art upon reading the following description of the drawings and the detailed description thereof.

### BRIEF DESCRIPTION OF THE DRAWINGS

The present invention will become more fully apparent from the following description and appended claims, taken in conjunction with the accompanying drawings. Understanding that the accompanying drawings depict only typical embodiments, and are, therefore, not to be considered to be limiting of the scope of the present disclosure, the embodiments will be described and explained with specificity and detail in reference to the accompanying drawings as provided below.

FIG. 1 is a chart identifying various facial properties/features (under the column titled “Category”), along with columns that identify the perceived state of such features;

FIG. 2 is a first exemplar of two identified facial features along with representations of perceived aging states of such feature; and,

FIG. 3 is a second exemplar of two identified facial features along with representations of perceived aging states of such feature.

### DETAILED DESCRIPTION OF THE PRESENT INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

Reference throughout this description to features, advantages, objects or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, any discussion of the features and advantages, and similar language, throughout this specification may, but does not necessarily, refer to the same embodiment.

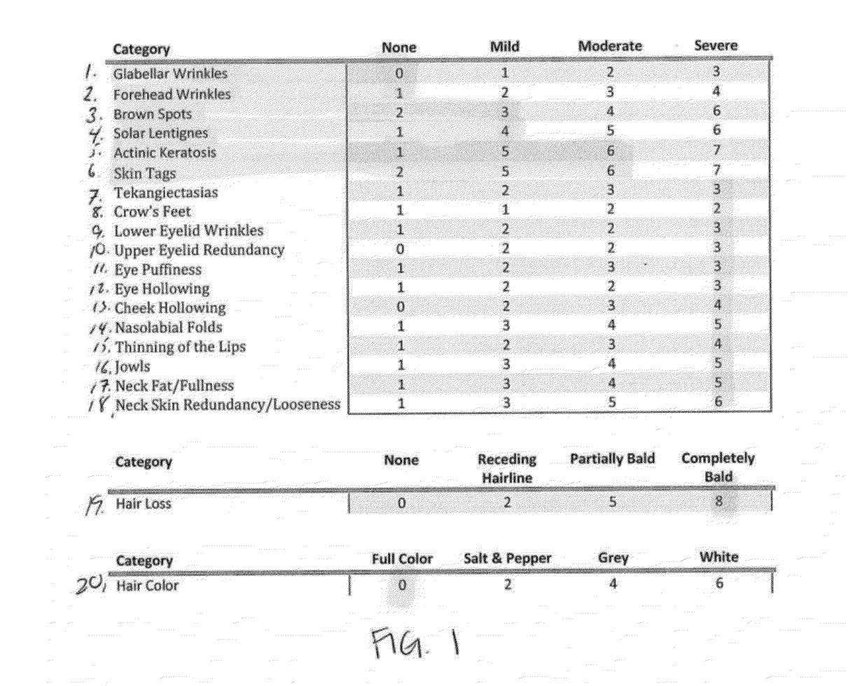

A chart identifying categories of various aging related features associated with the face, neck and hair of individuals, along with columns identifying levels of perceived severity for same is shown in FIG. 1. As can be seen, twenty separate categories have been identified as being indicative of changes that typically occur to the face, neck and hair during the human aging process. It should be noted that although twenty categories have been identified, less or more, as well as different categories are also contemplated by the present invention.

A level of perceived severity associated with each of the identified Categories is represented in the Chart of FIG. 1 with the column headings: “None,” “Mild,” “Moderate” and “Severe.” These levels represent the existence, state of advancement and/or noticeability of the categories of the depicted age related features. A number is identified under each of the levels of severity for each of the age related features.

In the preferred embodiment of the invention, these numbers are based on a weighted system wherein such things as the nature of the age related feature and its typical impact on the perceived (vs. actual) aging process are taken into consideration.

For example, moderate existence of Glabellar Wrinkles does not impart as noticeable of an increase in perceived age as does the moderate existence of, Solar Lentigness, which does not impart as noticeable of an increase in perceived age as the moderate existence of Skin Tags. The appropraite level of severity is readily determinable by those having ordinary skill in the art.

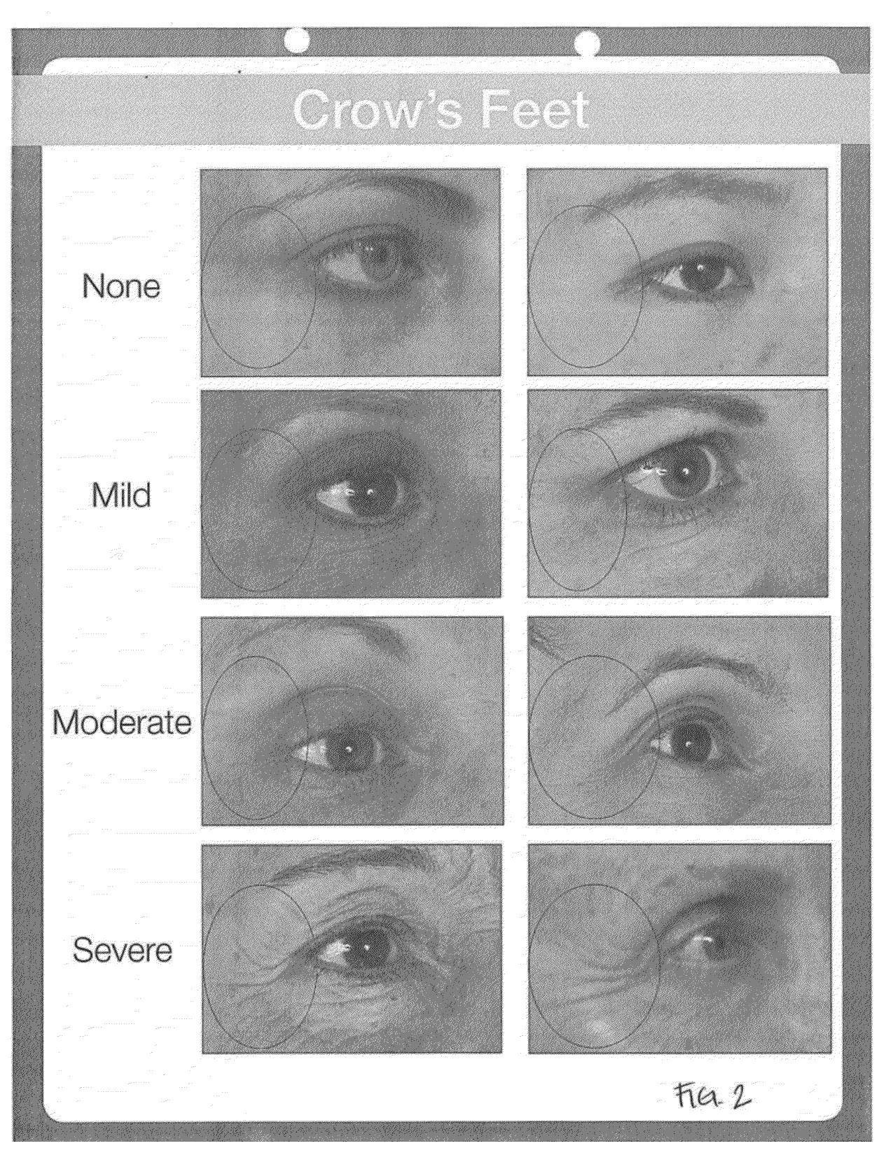

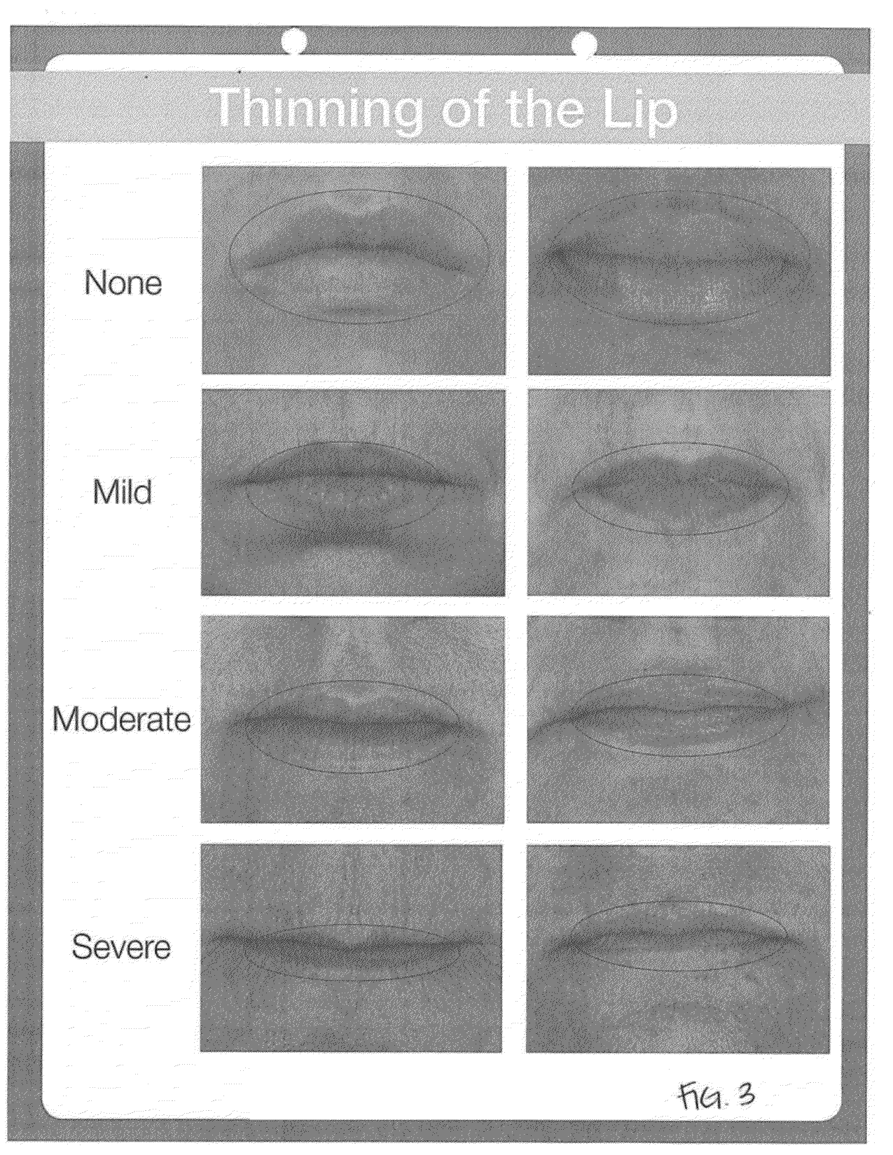

Examples of four identified levels of severity are shown in FIG. 2 and FIG. 3 for “Crows Feet” and “Thinning of the Lips,” respectively.

Relying upon data, such as the data depicted in FIG. 1, provides a road map not only in determining the perceived age of an individual, but also, in providing a plethora of cosmetic and/or surgical options for altering the perceived age of that individual.

In particular, a plastic surgeon, for example, can look at each of the features in the categories in FIG. 1 and then identify the state of existence of each of those features on an individual concerned about his or her perceived age. After determining the level of existence of each of the features, the plastic surgeon would then simply add all of the numbers up associated with each feature and their respective level of severity. This total number would be representative of the perceived age of that individual.

For example, out of the twenty identified categories in FIG. 1, it may be determined that Categories 1, 2 and 20 (e.g., Glabellar Wrinkles, Forehead Wrinkles, and state of hair color aging) are non-existent on the patient. Accordingly, those three categories would be attributed with a “0,” “1,” and “0” rating, respectively, for a sub-total of 1 (0+1+0=1). Categories 3 and 4 (Brown Spots and Solar Lentignes) may be determined to exist, but only in a mild state. Accordingly, those two categories would receive ratings of “3” and “4,” respectively, for a sub-total of “7” (3+4=7). Categories 5 and 6 (Actinic Keratosis and Skin Tags) may be perceived to exist on the individual in a moderate state. Accordingly, those two categories would receive ratings of “6” and “6,” respectively, for a sub-total of “12.” Finally, the remaining categories (identified as Categories 7-19) may be perceived to each exist in a sever state. Accordingly, the number associated with each of those categories, in a sever state would be added together for a sub-total of “54.” Then, adding all of the sub-totals together would provide a representation of the perceived (vs. actual) age of the individual: in this case, 1+7+12+54=74 years old (perceived).

Having the information in hand (the perceived age) and the numerical representations associated with the particular categories, a doctor can, for example, identify cosmetic and/or surgical alterations relative to reducing or eliminating the severity of one or more of the evaluated age related features/categories, and, in turn, reducing the perceived age of the individual.

For example, and based upon the perceived age of 74 (taken from the example above), a decision could be made to completely eliminate Skin Tags, thicken lips so that the severity rating would go from “Severe” to “Mild” and repair hair growth/hair condition from “Completely Bald” to a “Receding Hairline.” If such changes were made, then the new calculations would identify that the individual would go from a perceived age of 74 down to a perceived age of 63. Of course further, or other alternative cosmetic or surgical modifications to other ones of the age related features could be made to the individual depending upon medical practicality, desired age and desired modifications/alterations, among other things.

To assist an individual, and the doctor, for example, in making a determination of which of the age related features could and/or should be altered (lowering their respective level of severity, and, in turn, reducing the perceived age of the individual), the invention further contemplates the use of graphical representations for “before” and “after” analysis. In a preferred embodiment of the invention, a monitor (or TV screen or the like) would show a picture of the individual before any final decision has been made as to which, if any, cosmetic or surgical modifications to the age related features were made. Another picture of that same individual would be shown on the monitor (side-by-side) wherein a computer would modify the image of the individual's picture to incorporate the contemplated cosmetic and/or surgical modifications. Accordingly, the individual can actually “try on” several different possible modifications, before going through with same, until the individual determines which of the features he or she would prefer.

It is also contemplated that as the computer modifies the picture of the individual, that it likewise calculate the “new” perceived age of that individual based upon the numerical weighting system as previously described, as each alternative modification to the picture of that individual is made. Although only a few preferred embodiments of the present invention have been disclosed herein, it should be understood that other embodiments are also contemplated. For example, other categories of age related features and different methodologies for determining relevant numerical weights, and, in turn, perceived age, could be used. Also, rather than pictures of individuals, computer generated representations, among other things, could be used. Additional variations will be understood to those having ordinary skill in the art having the present specification, claims and drawings (Figures) before them.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

What is claimed is:

1. A method for determining the perceived age of an individual comprising the steps of:
identifying one or more aging related facial features associated with a human's face;
identifying a perceived state to each of such features;
assigning a numerical representation to each feature based upon the perceived state of such features;
calculating the assigned numerical representations associated with each of the perceived states of each of such features, wherein such a calculation results in a perceived age of the individual, regardless of the individual's true age.

2. The method according to claim 1, wherein the step of identifying one or more aging related facial features includes identifying one or more of various locations on an individual's face prone to wrinkles, skin alterations, skin elasticity, skin folds, muscle condition, lip condition, cheek properties and eye area properties.

3. The method according to claim 1, wherein the step of identifying one or more aging related facial features includes identifying one or more of the features selected from the group consisting of: Glabellar Wrinkles; Forehead Wrinkles; Brown Spots; Solar Lentignes; Actinic Keratosis; Skin Tags; Tekangiectasias; Crow's Feet; Lower Eyelid Wrinkles; Upper Eyelid Redundancy; Eye Puffiness; Eye Hollowing; Cheek Hollowing; Nasolabial Folds; Thinning of the Lips; Jowls; Neck Fat/Fullness; Neck Skin Redundancy/Looseness; Hair Loss; and, Hair Color.

4. The method according to claim 1, wherein the step of identifying a perceived state comprises the step of determining whether such a perceived state is non-existent, mild, moderate or severe.

5. The method according to claim 1, wherein the step of assigning numerical representations comprises assigning a predetermined number based upon one or more of the state of the age related feature and the perceived impact such a state has on the perceived age of individuals.

6. The method according to claim 5, wherein the step of assigning a predetermined number comprises assigning numbers for age related features selected from the group consisting of: Glabellar Wrinkles; Forehead Wrinkles; Brown Spots; Solar Lentignes; Actinic Keratosis; Skin Tags; Tekangiectasias; Crow's Feet; Lower Eyelid Wrinkles; Upper Eyelid Redundancy; Eye Puffiness; Eye Hollowing; Cheek Hollowing; Nasolabial Folds; Thinning of the Lips; Jowls; Neck Fat/Fullness; Neck Skin Redundancy/Looseness; Hair Loss; and, Hair Color.

7. The method according to claim 1, wherein the step of calculating the assigned numerical representations associated with each of the perceived states of each of such features, comprises determining the perceived age of the individual by adding the assigned numbers together.

8. The method according to claim 1 further including the step of altering one or more of the perceived states, and, in turn, identifying a new perceived age of the individual based upon such alterations.

9. The method of claim 8, wherein the step of altering comprises the step altering graphically, via computer generation, cosmetically and/or surgically.

10. A system for estimating a perceived age of an individual and for altering the individual's facial appearance to a desired perceived age, wherein the system comprises:
a data base indicating one or more facial, neck and hair features associated with aging, wherein the data base includes numerical representations associated with one or more levels of severity associated with each particular feature; and
means for determining a perceived age of an individual based upon the severity of the age related features.

11. The invention according to claim 10 further including means for altering one or more of the age related features to a lower level of severity.

12. The invention according to claim 11, wherein the altering means comprises a computer generated image of the individual with the altered features.

13. The invention according to claim 12, wherein the altering means includes a comparison of the individual's current features with the computer generated image.

14. The invention according to claim 11 further including means for providing a perceived age of an individual based upon an alteration of the severity of one or more of the age related features.

15. A method for determining the perceived age of an individual comprising the steps of:
identifying one or more aging related facial features associated with a human's face, wherein the aging related features are selected from the group consisting of: Glabellar Wrinkles; Forehead Wrinkles; Brown Spots; Solar Lentignes; Actinic Keratosis; Skin Tags; Tekangiectasias; Crow's Feet; Lower Eyelid Wrinkles; Upper Eyelid Redundancy; Eye Puffiness; Eye Hollowing; Cheek Hollowing; Nasolabial Folds;
Thinning of the Lips; Jowls; Neck Fat/Fullness; Neck Skin Redundancy/Looseness; Hair Loss; and, Hair Color;
identifying a perceived state to each of one or more aging related facial features, wherein for each of the one or more aging related facial features, the perceived state is identified as one of the following: on-existent, mild, moderate or severe;
assigning a numerical representation to each feature based upon the perceived state of such features;
adding the assigned numerical representations associated with each of the perceived states of each of such features, wherein such a result represents a perceived age of the individual, regardless of the individual's true age.
